(19) United States
(12) Patent Application Publication
(10) Pub. No.: US 2021/0409995 A1
(43) Pub. Date: Dec. 30, 2021

(54) Informing Upper Layer For Originating MMTEL Video Call During Network Congestion

(71) Applicant: MediaTek Inc., Hsinchu City (TW)

(72) Inventor: Kuan-Hua Lin, Hsinchu City (TW)

(21) Appl. No.: 17/336,693

(22) Filed: Jun. 2, 2021

Related U.S. Application Data
(60) Provisional application No. 63/045,212, filed on Jun. 29, 2020.

(51) Int. Cl. H04W 28/02; H04W 36/14

(52) U.S. Cl. CPC H04W 28/0247; H04W 36/14; H04W 28/0289

(57) ABSTRACT

Examples pertaining to informing an upper layer for originating a mobile originated multimedia telephony (MO-MMTEL) video call during network congestion in mobile communications are described. An apparatus (e.g., UE) identifies a need to initiate an MO-MMTEL video call over a first domain. The UE then determines that there is a condition related to initiating the MO-MMTEL video call over the first domain. In response to the determining, the UE initiates the MO-MMTEL video call over a second domain different than the first domain.

### CROSS REFERENCE TO RELATED PATENT APPLICATION(S)

The present disclosure is part of a non-provisional application claiming the priority benefit of U.S. Patent Application No. 63/045,212, filed on 29 Jun. 2020, the content of which being incorporated by reference in its entirety.

### TECHNICAL FIELD

The present disclosure is generally related to mobile communications and, more particularly, to informing upper layer for originating multimedia telephony (MMTEL) during network congestion in mobile communications.

### BACKGROUND

Unless otherwise indicated herein, approaches described in this section are not prior art to the claims listed below and are not admitted as prior art by inclusion in this section.

In an Evolved Packet System (EPS) and a 5th Generation System (5GS) based on the 3^{rd} Generation Partnership Project (3GPP) standards, a user equipment (UE) or a mobile device can initiate a video call over Internet Protocol (IP) Multimedia Subsystem (IMS), which is also known as an MMTEL video call. When initiating a mobile originated (MO)-MMTEL video call, the UE may need to initiate a certain procedure depending on the situation at the time. For example, the UE may need to initiate a service request procedure in case the required radio resource for IMS signaling has not been established. As another example, the UE may need to initiate a tracking area update (TAU) procedure in EPS in case the UE is in an EPS Mobility Management (EMM)-REGISTERED.ATTEMPTING-TO-UPDATE state. As yet another example, the UE may need to initiate a registration procedure for mobility and periodic registration update in 5GS in case the UE is in a 5^{th} Generation Mobility Management (5G MM)-REGISTERED.ATTEMPTING-REGISTRATION-UPDATE state.

It is possible that, when the UE needs to perform one of the above-listed procedures for initiating an MO-MMTEL video call, the network is congested and hence is not able to provide the service. However, as specified in the current 3GPP Technical Specification (TS) 24.501 and TS 24.301, there is no notification sent to an upper layer, namely an IMS entity at the UE side, when the aforementioned issue arises. As a result there could be an unacceptably long waiting period before the MO-MMTEL video call can be initiated, thereby resulting in poor user experience. Therefore, there is a need for a solution to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to informing an upper layer for originating an MO-MMTEL video call during network congestion in mobile communications. It is believed that the above-described issue would be avoided or otherwise alleviated by implementing one or more of the proposed schemes described herein.

In one aspect, a method may involve identifying a need to initiate an MO-MMTEL video call over a first domain. The method may also involve determining that there is a condition related to initiating the MO-MMTEL video call over the first domain. The method may further involve initiating the MO-MMTEL video call over a second domain different than the first domain responsive to the determining.

In another aspect, a method may involve transmitting a request to a network to initiate a procedure to establish an MO-MMTEL video call over a first domain. The method may also involve receiving a rejection from the network responsive to transmitting the request. The method may further involve initiating the MO-MMTEL video call over a second domain different than the first domain responsive to receiving the rejection.

In still another aspect, an apparatus may include a transceiver and a processor coupled to the transceiver. The transceiver may be configured to communicate wirelessly with a network. The processor may be configured to perform operations involving: (a) identifying a need to initiate an MO-MMTEL video call over a first domain; (b) determining that there is a condition that prevents initiating the MO-MMTEL video call over the first domain; and (c) initiating, via the transceiver, the MO-MMTEL video call over a second domain different than the first domain responsive to the determining.

It is noteworthy that, although description provided herein may be in the context of certain radio access technologies, networks and network topologies such as 5G/New Radio (NR) mobile networking, the proposed concepts, schemes and any variation(s)/derivative(s) thereof may be implemented in, for and by other types of wireless and wired communication technologies, networks and network topologies such as, for example and without limitation, Ethernet, Evolved Packet System (EPS), Universal Terrestrial Radio Access Network (UTRAN), Evolved UTRAN (E-UTRAN), Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, Internet-of-Things (IoT), Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in an implementation in accordance with the present disclosure.

FIG. 3 is a diagram of an example scenario in an implementation in accordance with the present disclosure.

FIG. 4 is a diagram of an example scenario in an implementation in accordance with the present disclosure.

FIG. 5 is a diagram of an example scenario in an implementation in accordance with the present disclosure.

FIG. 6 is a diagram of an example logic flow in an implementation in accordance with the present disclosure.

FIG. 7 is a diagram of an example scenario in an implementation in accordance with the present disclosure.

FIG. 8 is a diagram of an example scenario in an implementation in accordance with the present disclosure.

FIG. 9 is a diagram of an example scenario in an implementation in accordance with the present disclosure.

FIG. 10 is a diagram of an example scenario in an implementation in accordance with the present disclosure.

FIG. 11 is a diagram of an example logic flow in an implementation in accordance with the present disclosure.

FIG. 12 is a block diagram of an example communication system in accordance with an implementation of the present disclosure.

FIG. 13 is a flowchart of an example process in accordance with an implementation of the present disclosure.

FIG. 14 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to informing an upper layer for originating an MO-MMTEL video call during network congestion in mobile communications. According to the present disclosure, a number of possible solutions may be implemented separately or jointly. That is, although these possible solutions may be described below separately, two or more of these possible solutions may be implemented in one combination or another.

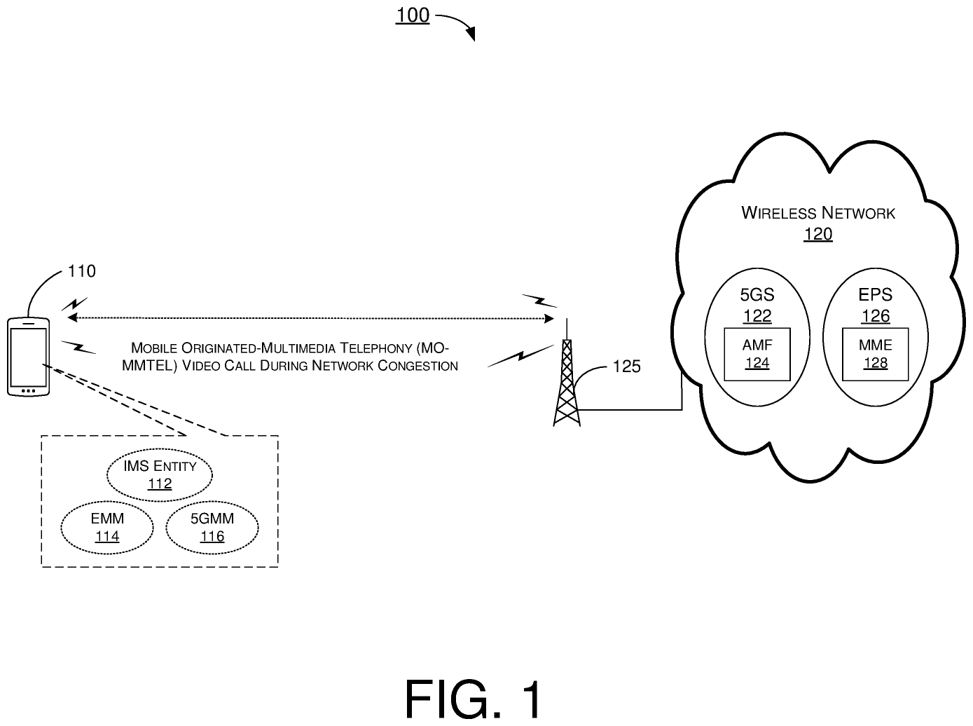

FIG. 1 illustrates an example network environment 100 in which various solutions and schemes in accordance with the present disclosure may be implemented. Referring to FIG. 1, network environment 100 may involve a UE 110 and a wireless network 120. UE 110 and network 120 may be in wireless communications via one or more network nodes (e.g., eNBs, gNBs and/or transmit/receive points (TRPs) including a network node 125. Network 120 may include a 5GS network 122 and an EPS network 126. UE 110 may include, among other components and functionalities, an IMS entity 112 (herein interchangeably referred to as IMS function 112), an EMM 114 (herein interchangeably referred to as EMM function 114), and a 5GMM 116 (herein interchangeably referred to as 5GMM function 116). 5GS network 122 may include, among other components and functionalities, an Access and Mobility Management (AMF) 124. EPS network 126 may include, among other components and functionalities, a Mobility Management Entity (MME) 128. In network environment 100, UE 110 and wireless network 120 may be configured to implement various schemes pertaining to informing an upper layer for originating an MO-MMTEL video call during network congestion in mobile communications in accordance with the present disclosure, as described herein.

In an event that UE 110 needs to initiate and perform a certain procedure (e.g., a service request procedure, a TAU procedure or a registration procedure for mobility and periodic registration update) in order to initiate an MO-MMTEL video call, a request by UE 110 to initiate such a procedure may be rejected by network 120 due to network 120 being congested. For example, network 120 may reject the requested procedure initiation with an EMM cause #22 (indicating congestion) or a 5GMM cause #22 (indicating congestion). As another example, UE 110 may fail to initiate the service request procedure or TAU procedure in EPS. Alternatively, UE 110 may fail to initiate the registration procedure for mobility and periodic registration update due to a backoff timer T3346, or a backoff timer T3525 running.

Timer T3346 is a timer for congestion control in a network based on the 3GPP standard (e.g., an EPS network or a 5GS network). The default duration of T3346 is 15-30 minutes and its value may be indicated in a service reject, TAU reject or registration reject message. UE 110 may start a corresponding timer upon receiving the timer value. When T3346 is running, UE 110 usually cannot initiate procedures except for special cases specified in 3GPP TS 24.501 chapter 5.2.3.2.3 or TS 24.301 chapter 5.2.3.2.2. Timer T3325 is a timer for suspending the initiation of a service request procedure temporarily after five consecutive attempt fails in abnormal cases in EPS. The default duration of T3325 is 60 seconds. Timer T3525 is a timer for suspending the initiation of a service request procedure temporarily after five consecutive attempt fails in abnormal cases in 5GS. The default duration of T3525 is 60 seconds. Thus, in case a request for a certain procedure (e.g., a service request procedure, a TAU procedure or a registration procedure for mobility and periodic registration update) to initiate an MO-MMTEL video call is rejected by network 120 due to timer T3346, T3325 or T3525 running, UE 110 may need to wait for a long period ranging from several seconds to 30 minutes, which would be unacceptable.

Under various proposed schemes in accordance with the present disclosure, the interaction between IMS entity 112 and EMM 114 in UE 110 as well as the interaction between IMS entity 112 and 5GMM 116 in UE 110 may be considered. Specifically, an MO-MMTEL video call may be retried over one or more other domains, such as circuit-switched (CS) domain and/or Wi-Fi access for example, by the EMM or 5GMM in UE 110 providing a notification to an upper layer (e.g., IMS entity) in UE 110 about the failed initiation of one of the aforementioned procedures. Accordingly, this may enable UE 110 to provide better user experience of a user of UE 110 on call performance in case there is network congestion in EPS or 5GS. This is because IMS entity 112 may be able to initiate and establish the MO-MMTEL video call over one or more other domains due to EMM 114 or 5GMM 116 notifying IMS entity 112 of a failure in initiation the video call upon determining that there is network congestion, rather than waiting for the network congestion to be over and/or retrying to initiate/establish the MO-MMTEL video call in the same/original domain.

Under a proposed scheme in accordance with the present disclosure, EMM 114 in UE 110 may provide a notification to the upper layer (e.g., IMS entity 112) in UE 110 in an event that a service request procedure or a TAU procedure for initiating an MO-MMTEL video call is rejected by network 120 with an EMM cause #22 (congestion) and a T3346 value. For instance, in case a service request procedure for initiating an MO-MMTEL video call cannot be initiated due to T3346 or T3325 running, EMM 114 may provide a notification to the upper layer. Moreover, in case a TAU procedure for initiating an MO-MMTEL video call cannot be initiated due to T3346 running, EMM 114 may provide a notification to the upper layer.

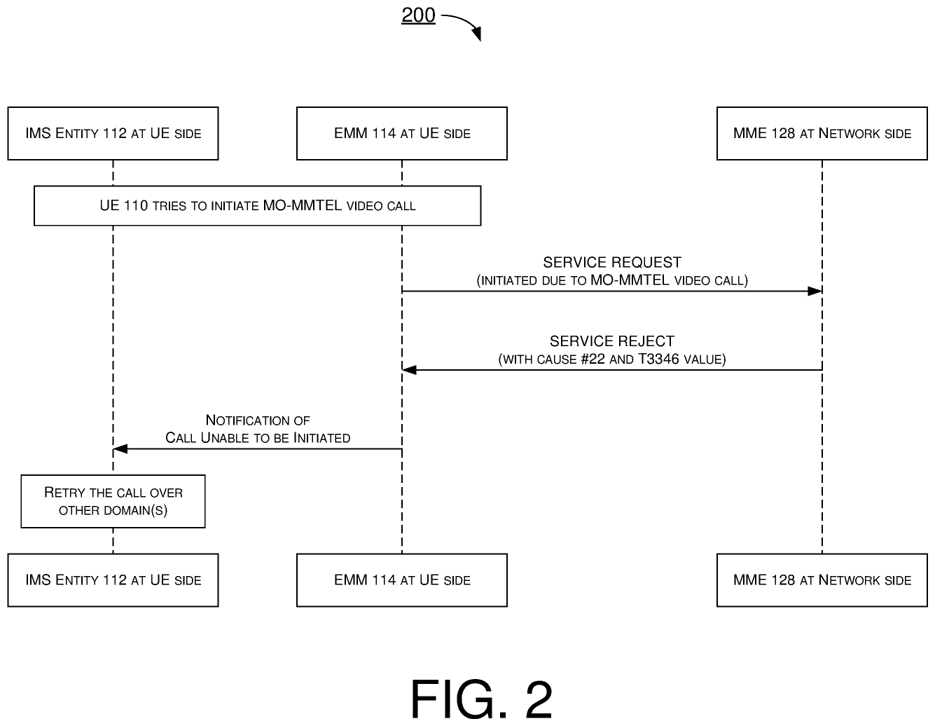

FIG. 2 illustrates an example scenario 200 in an implementation in accordance with the present disclosure. Scenario 200 may involve IMS entity 112 and EMM 114 in UE 110 as well as MME 128 in network 120. In scenario 200, UE 110 may attempt to initiate an MO-MMTEL video call (e.g., as a result of receiving a user input by UE 110). Accordingly, EMM 114 may send a SERVICE REQUEST to MME 128 for initiating the MO-MMTEL video call. However, due to network congestion, MME 128 may send a SERVICE REJECT with cause #22 and a T3346 value to EMM 114. Under a proposed scheme in accordance with the present disclosure, upon receiving the SERVICE REJECT with cause #22 and a T3346 value, EMM 114 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

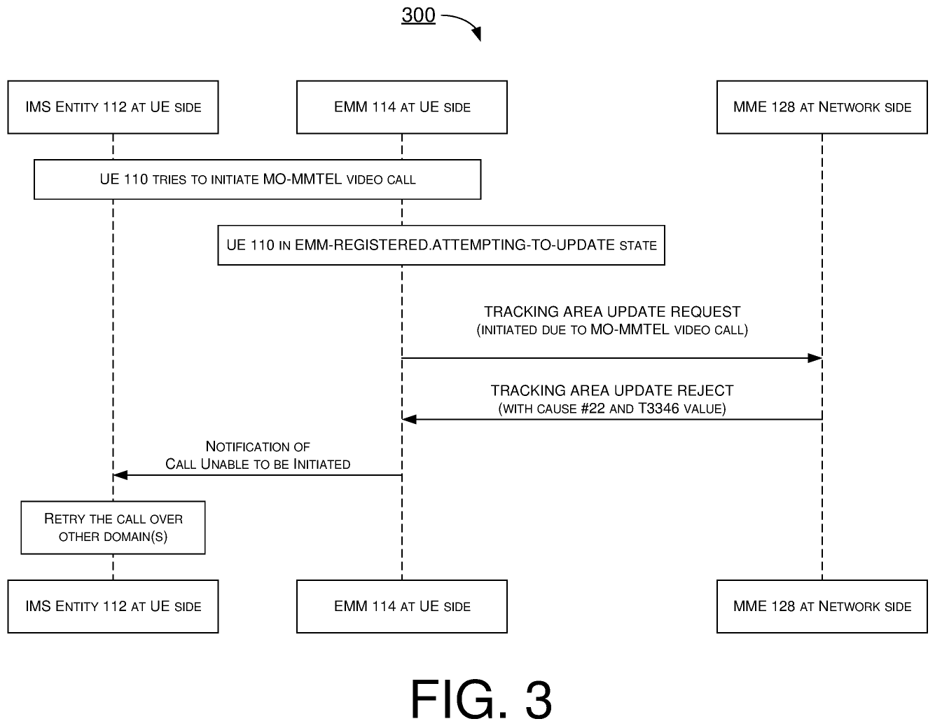

FIG. 3 illustrates an example scenario 300 in an implementation in accordance with the present disclosure. Scenario 300 may involve IMS entity 112 and EMM 114 in UE 110 as well as MME 128 in network 120. In scenario 300, UE 110 may attempt to initiate an MO-MMTEL video call (e.g., as a result of receiving a user input by UE 110) while UE 110 is in an EMM-REGISTERED.ATTEMPTING-TO-UPDATE state. Accordingly, EMM 114 may send a TRACKING AREA UPDATE REQUEST to MME 128 for initiating the MO-MMTEL video call. However, due to network congestion, MME 128 may send a TRACKING AREA UPDATE REJECT with cause #22 and a T3346 value to EMM 114. Under a proposed scheme in accordance with the present disclosure, upon receiving the TRACKING AREA UPDATE REJECT with cause #22 and a T3346 value, EMM 114 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

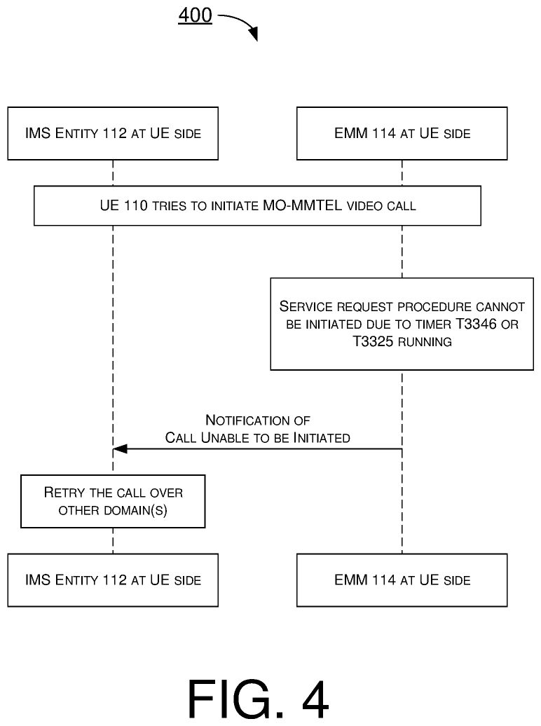

FIG. 4 illustrates an example scenario 400 in an implementation in accordance with the present disclosure. Scenario 400 may involve IMS entity 112 and EMM 114 in UE 110. In scenario 400, UE 110 may attempt to initiate an MO-MMTEL video call (e.g., as a result of receiving a user input by UE 110). However, EMM 114 may determine that a service request procedure cannot be initiated since timer T3346 or T3325 is running. Under a proposed scheme in accordance with the present disclosure, upon determining that the service request procedure cannot be initiated due to timer T3346 or T3325 running, EMM 114 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

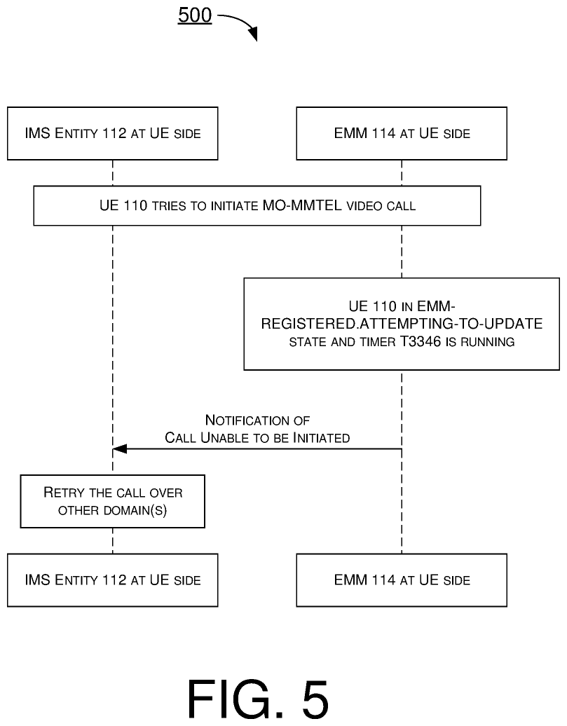

FIG. 5 illustrates an example scenario 500 in an implementation in accordance with the present disclosure. Scenario 500 may involve IMS entity 112 and EMM 114 in UE 110. In scenario 500, UE 110 may attempt to initiate an MO-MMTEL video call (e.g., as a result of receiving a user input by UE 110). However, EMM 114 may determine that UE 110 is in an EMM-REGISTERED.ATTEMPTING-TO-UPDATE state and that timer T3346 is running. Under a proposed scheme in accordance with the present disclosure, upon determining that UE 110 is in the EMM-REGISTERED.ATTEMPTING-TO-UPDATE state and that timer T3346 is running, EMM 114 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

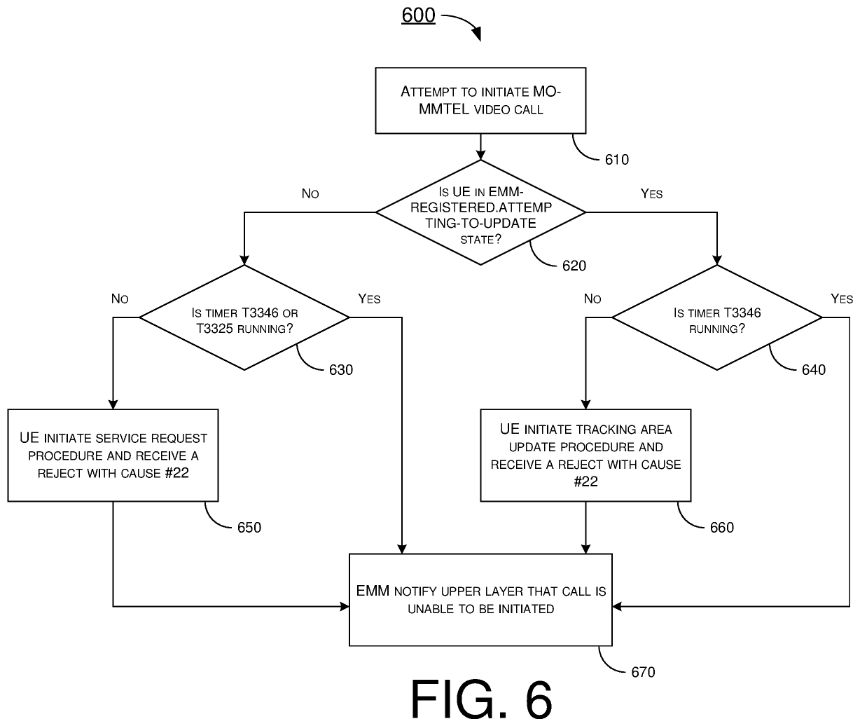

FIG. 6 illustrates an example logic flow 600 in an implementation in accordance with the present disclosure. Logic flow 600 may represent an aspect of implementing various proposed designs, concepts, schemes, systems and methods described above, whether partially or entirely, including those described above. More specifically, logic flow 600 may represent an aspect of the proposed concepts and schemes pertaining to informing an upper layer for originating an MO-MMTEL video call during network congestion in mobile communications. Logic flow 600 may include one or more operations, actions, or functions as illustrated by one or more of blocks 610, 620, 630, 640, 650, 660 and 670. Although illustrated as discrete blocks, various blocks of Logic flow 600 may be divided into additional blocks, combined into fewer blocks, or eliminated, depending on the desired implementation. Furthermore, one or more of the blocks/sub-blocks of Logic flow 600 may be executed iteratively. Logic flow 600 may be implemented by or in UE 110 and network 120 as well as any variations thereof. Logic flow 600 may begin at block 610.

At 610, UE 110 may attempt to initiate an MO-MMTEL video call. Logic flow 600 may proceed from 610 to 620.

At 620, EMM 114 in UE 110 may determine whether UE 110 is in an EMM-REGISTERED.ATTEMPTING-TO-UPDATE state. Logic flow 600 may proceed from 620 to 630 or 640 depending on an outcome of the determination.

At 630, in response to determining that UE 110 is not in the EMM-REGISTERED.ATTEMPTING-TO-UPDATE state, EMM 114 may also determine whether a timer T3346 or T3325 is running. Logic flow 600 may proceed from 630 to 650 or 670 depending on an outcome of the determination. Specifically, logic flow 600 may proceed from 630 to 650 in response to determining that timer T3346 is not running, and logic flow 600 may proceed from 630 to 670 in response to determining that timer T3346 is running.

At 640, in response to determining that UE 110 is in the EMM-REGISTERED.ATTEMPTING-TO-UPDATE state, EMM 114 may also determine whether a timer T3346 is running. Logic flow 600 may proceed from 640 to 660 or 670 depending on an outcome of the determination. Specifically, logic flow 600 may proceed from 640 to 660 in response to determining that timer T3346 is not running, and logic flow 600 may proceed from 640 to 670 in response to determining that timer T3346 is running.

At 650, EMM 114 may initiate a service request procedure and, in response, receive a reject with cause #22. Logic flow 600 may proceed from 650 to 670.

At 660, EMM 114 may initiate a TAU procedure and, in response, receive a reject with cause #22. Logic flow 600 may proceed from 660 to 670.

At 670, EMM 114 may notify an upper layer (e.g., IMS entity 112) that the MO-MMTEL video call is unable to be initiated to cause the upper layer to retry or otherwise re-attempt to initiate and establish the MO-MMTEL video call over one or more other domains (e.g., CS domain and/or Wi-Fi access).

Under a proposed scheme in accordance with the present disclosure, 5GMM 116 at the UE side in UE 110 may provide a notification to the upper layer (e.g., IMS entity 112) in UE 110 in an event that a service request procedure or a registration procedure for mobility and periodic registration update for initiating an MO-MMTEL video call is rejected by network 120 with a 5GMM cause #22 (congestion) and a T3346 value. For instance, in case a service request procedure for initiating an MO-MMTEL video call cannot be initiated due to T3346 or T3525 running, 5GMM 116 may provide a notification to the upper layer. Moreover, in case a registration procedure for mobility and periodic registration update for initiating an MO-MMTEL video call cannot be initiated due to T3346 running, 5GMM 116 may provide a notification to the upper layer.

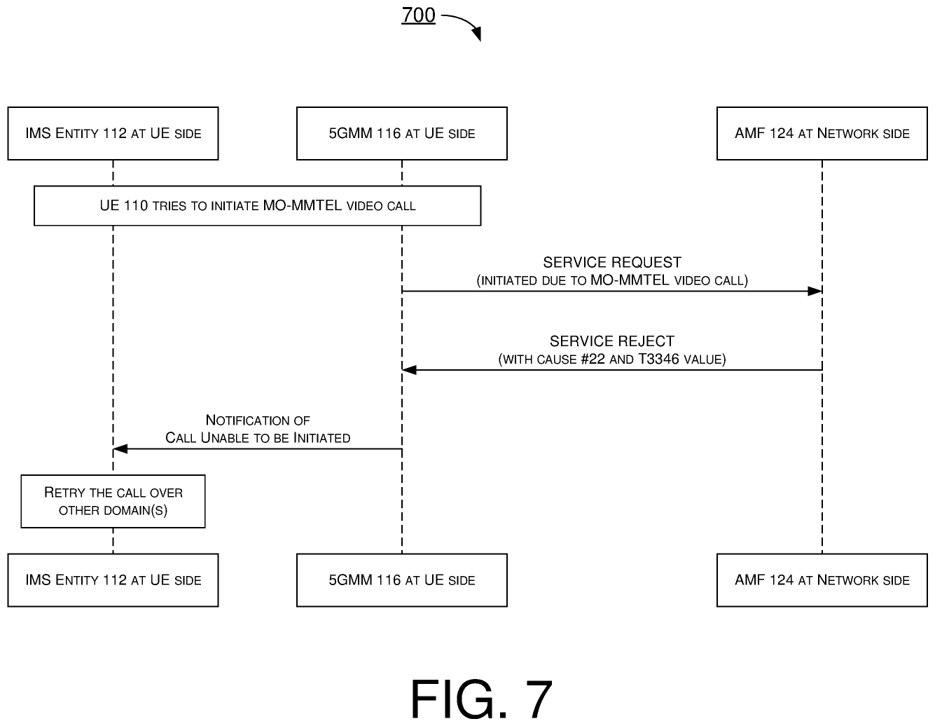

FIG. 7 illustrates an example scenario 700 in an implementation in accordance with the present disclosure. Scenario 700 may involve IMS entity 112 and 5GMM 116 in UE 110 as well as AMF 124 in network 120. In scenario 700, UE 110 may attempt to initiate an MO-MMTEL video call (e.g., as a result of receiving a user input by UE 110). Accordingly, 5GMM 116 may send a SERVICE REQUEST to AMF 124 for initiating the MO-MMTEL video call. However, due to network congestion, AMF 124 may send a SERVICE REJECT with cause #22 and a T3346 value to 5GMM 116. Under a proposed scheme in accordance with the present disclosure, upon receiving the SERVICE REJECT with cause #22 and a T3346 value, 5GMM 116 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

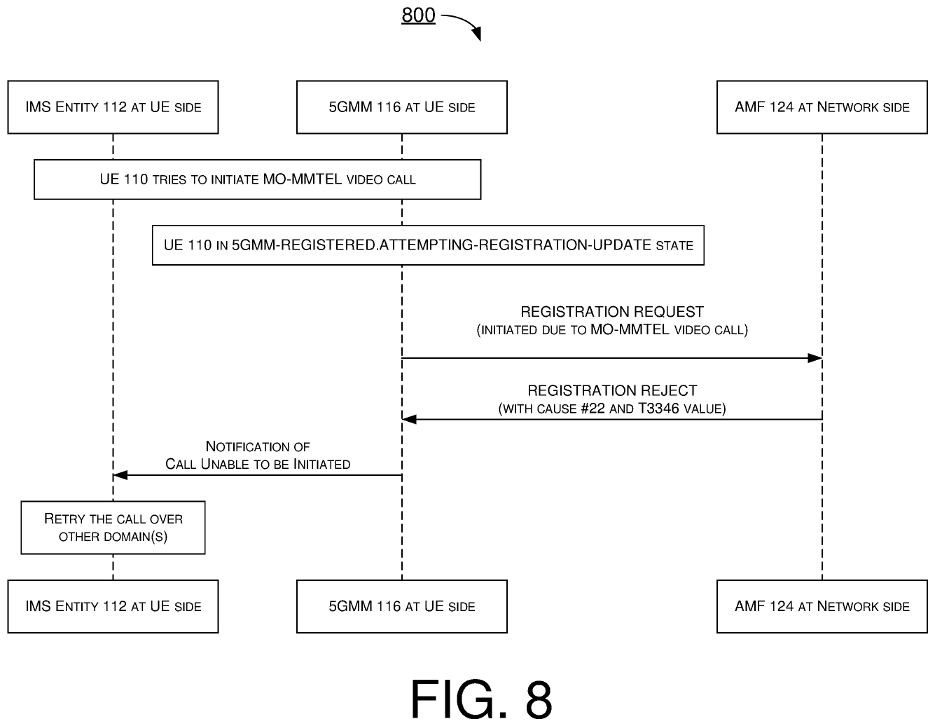

FIG. 8 illustrates an example scenario 800 in an implementation in accordance with the present disclosure. Scenario 800 may involve IMS entity 112 and 5GMM 116 in UE 110 as well as AMF 124 in network 120. In scenario 800, UE 110 may attempt to initiate an MO-MMTEL video call (e.g., as a result of receiving a user input by UE 110) while UE 110 is in a 5GMM-REGISTERED.ATTEMPTING-REGISTRATION-UPDATE state. Accordingly, 5GMM 116 may send a REGISTRATION REQUEST to AMF 124 for initiating the MO-MMTEL video call. However, due to network congestion, AMF 124 may send a REGISTRATION REJECT with cause #22 and a T3346 value to 5GMM 116. Under a proposed scheme in accordance with the present disclosure, upon receiving the REGISTRATION REJECT with cause #22 and a T3346 value, 5GMM 116 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

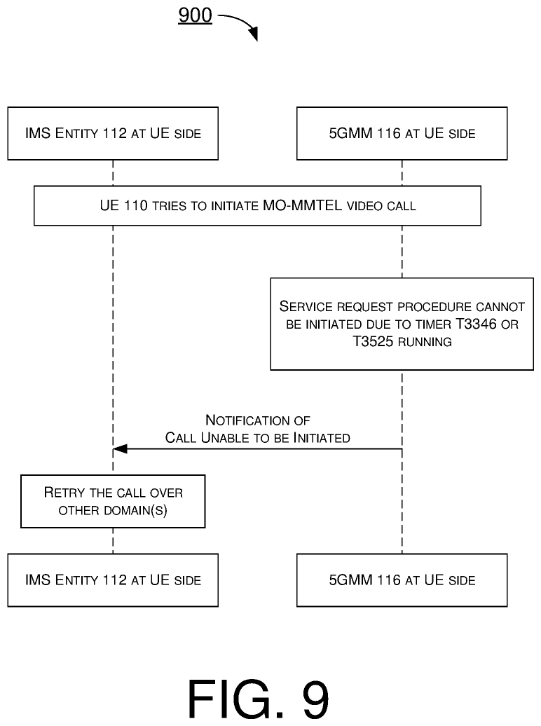

FIG. 9 illustrates an example scenario 900 in an implementation in accordance with the present disclosure. Scenario 900 may involve IMS entity 112 and 5GMM 116 in UE 110. In scenario 900, UE 110 may attempt to initiate an MO-MMTEL video call (e.g., as a result of receiving a user input by UE 110). However, 5GMM 116 may determine that a service request procedure cannot be initiated since timer T3346 or T3525 is running. Under a proposed scheme in accordance with the present disclosure, upon determining that the service request procedure cannot be initiated due to timer T3346 or T3525 running, 5GMM 116 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

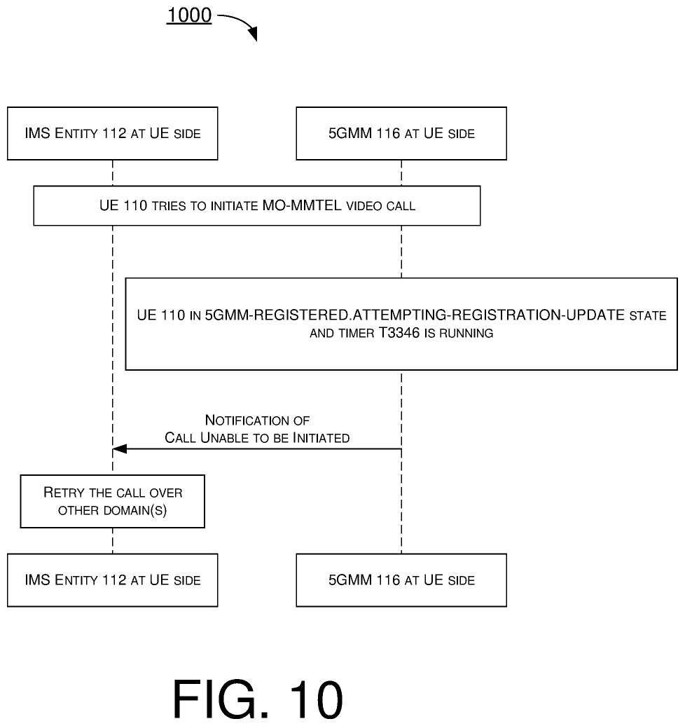

FIG. 10 illustrates an example scenario 1000 in an implementation in accordance with the present disclosure. Scenario 1000 may involve IMS entity 112 and 5GMM 116 in UE 110. In scenario 1000, UE 110 may attempt to initiate an MO-MMTEL video call (e.g., as a result of receiving a user input by UE 110). However, 5GMM 116 may determine that UE 110 is in a 5GMM-REGISTERED.ATTEMPTING-REGISTRATION-UPDATE state and that timer T3346 is running. Under a proposed scheme in accordance with the present disclosure, upon determining that UE 110 is in the 5GMM-REGISTERED.ATTEMPTING-REGISTRATION-UPDATE state and that timer T3346 is running, 5GMM 116 may provide a notification to IMS entity 112 of failure to initiate the MO-MMTEL video call. In response, IMS entity 112 may retry or otherwise re-attempt to initiate and establish the MO-MMTEL video call over one or more other domains (e.g., CS domain and/or Wi-Fi access).

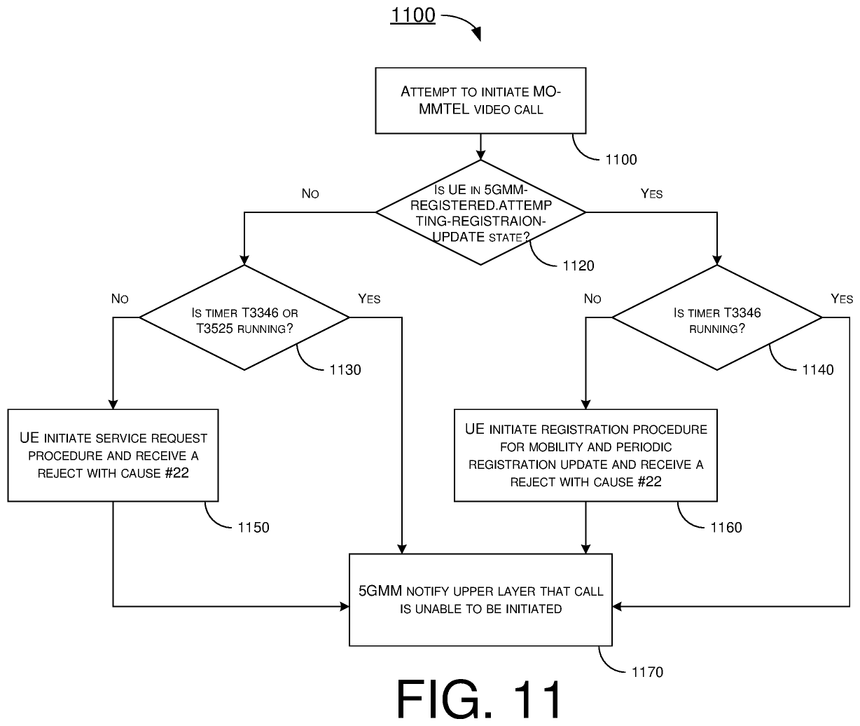

FIG. 11 illustrates an example scenario 1100 in an implementation in accordance with the present disclosure. Logic flow 1100 may represent an aspect of implementing various proposed designs, concepts, schemes, systems and methods described above, whether partially or entirely, including those described above. More specifically, logic flow 1100 may represent an aspect of the proposed concepts and schemes pertaining to informing an upper layer for originating an MO-MMTEL video call during network congestion in mobile communications. Logic flow 1100 may include one or more operations, actions, or functions as illustrated by one or more of blocks 1110, 1120, 1130, 1140, 1150, 1160 and 1170. Although illustrated as discrete blocks, various blocks of Logic flow 1100 may be divided into additional blocks, combined into fewer blocks, or eliminated, depending on the desired implementation. Moreover, Furthermore, one or more of the blocks/sub-blocks of Logic flow 1100 may be executed iteratively. Logic flow 1100 may be implemented by or in UE 110 and network 120 as well as any variations thereof. Logic flow 1100 may begin at block 1110.

At 1110, UE 110 may attempt to initiate an MO-MMTEL video call. Logic flow 1100 may proceed from 1110 to 1120.

At 1120, 5GMM 116 in UE 110 may determine whether UE 110 is in a 5GMM-REGISTERED.ATTEMPTING-REGISTRATION-UPDATE state. Logic flow 1100 may proceed from 1120 to 1130 or 1140 depending on an outcome of the determination.

At 1130, in response to determining that UE 110 is not in the 5GMM-REGISTERED.ATTEMPTING-REGISTRATION-UPDATE state, 5GMM 116 may also determine whether a timer T3346 or T3525 is running. Logic flow 1100 may proceed from 1130 to 1150 or 1170 depending on an outcome of the determination. Specifically, logic flow 1100 may proceed from 1130 to 1150 in response to determining that timer T3346 is not running, and logic flow 1100 may proceed from 1130 to 1170 in response to determining that timer T3346 is running.

At 1140, in response to determining that UE 110 is in the 5GMM-REGISTERED.ATTEMPTING-REGISTRATION-UPDATE state, 5GMM 116 may also determine whether a timer T3346 is running. Logic flow 1100 may proceed from 1140 to 1160 or 1170 depending on an outcome of the determination. Specifically, logic flow 1100 may proceed from 1140 to 1160 in response to determining that timer T3346 is not running, and logic flow 1100 may proceed from 1140 to 1170 in response to determining that timer T3346 is running.

At 1150, 5GMM 116 may initiate a service request procedure and, in response, receive a reject with cause #22. Logic flow 1100 may proceed from 1150 to 1170.

At 1160, 5GMM 116 may initiate a registration procedure for mobility and periodic registration update and, in response, receive a reject with cause #22. Logic flow 1100 may proceed from 1160 to 1170.

At 1170, 5GMM 116 may notify an upper layer (e.g., IMS entity 112) that the MO-MMTEL video call is unable to be initiated to cause the upper layer to retry or otherwise re-attempt to initiate and establish the MO-MMTEL video call over one or more other domains (e.g., CS domain and/or Wi-Fi access).

### Illustrative Implementations

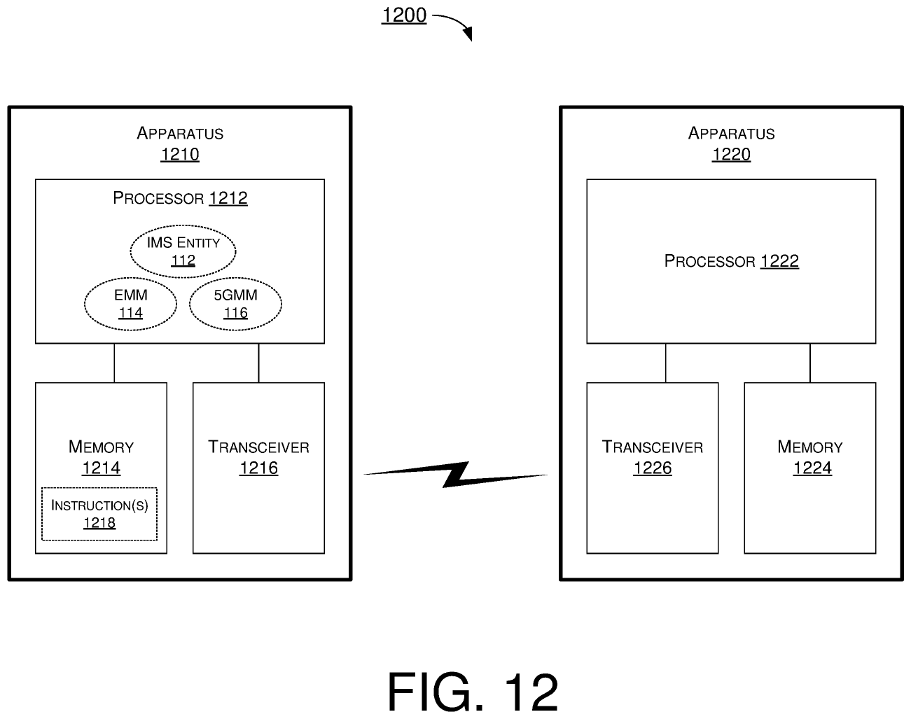

FIG. 12 illustrates an example communication system 1200 having at least an example apparatus 1210 and an example apparatus 1220 in accordance with an implementation of the present disclosure. Each of apparatus 1210 and apparatus 1220 may perform various functions to implement schemes, techniques, processes and methods described herein pertaining to informing an upper layer for originating an MO-MMTEL video call during network congestion in mobile communications, including the various schemes described above with respect to various proposed designs, concepts, schemes, systems and methods described above, including network environment 100, as well as processes described below.

Each of apparatus 1210 and apparatus 1220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1210 and apparatus 1220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 1210 and apparatus 1220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 1210 and apparatus 1220 may be implemented in a smart thermostat, a smart fridge, a smart door lock, a wireless speaker or a home control center. When implemented in or as a network apparatus, apparatus 1210 and/or apparatus 1220 may be implemented in an eNodeB in an LTE, LTE-Advanced or LTE-Advanced Pro network or in a gNB or TRP in a 5G network, an NR network or an IoT network.

In some implementations, each of apparatus 1210 and apparatus 1220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1210 and apparatus 1220 may be implemented in or as a network apparatus or a UE. Each of apparatus 1210 and apparatus 1220 may include at least some of those components shown in FIG. 12 such as a processor 1212 and a processor 1222, respectively, for example. Each of apparatus 1210 and apparatus 1220 may further include one or more other components not pertinent to the proposed scheme of the present disclosure (e.g., internal power supply, display device and/or user interface device), and, thus, such component(s) of apparatus 1210 and apparatus 1220 are neither shown in FIG. 12 nor described below in the interest of simplicity and brevity.

In one aspect, each of processor 1212 and processor 1222 may be implemented in the form of one or more single-core processors, one or more multi-core processors, or one or more CISC or RISC processors. That is, even though a singular term “a processor” is used herein to refer to processor 1212 and processor 1222, each of processor 1212 and processor 1222 may include multiple processors in some implementations and a single processor in other implementations in accordance with the present disclosure. In another aspect, each of processor 1212 and processor 1222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1212 and processor 1222 is a special-purpose machine specifically designed, arranged and configured to perform specific tasks including those pertaining to informing an upper layer for originating an MO-MMTEL video call during network congestion in mobile communications in accordance with various implementations of the present disclosure.

In some implementations, apparatus 1210 may also include a transceiver 1216 coupled to processor 1212. Transceiver 1216 may be capable of wirelessly transmitting and receiving data. In some implementations, transceiver 1216 may be capable of wirelessly communicating with different types of wireless networks of different radio access technologies (RATs). In some implementations, transceiver 1216 may be equipped with a plurality of antenna ports (not shown) such as, for example, four antenna ports. That is, transceiver 1216 may be equipped with multiple transmit antennas and multiple receive antennas for multiple-input multiple-output (MIMO) wireless communications. In some implementations, apparatus 1220 may also include a transceiver 1226 coupled to processor 1222. Transceiver 1226 may include a transceiver capable of wirelessly transmitting and receiving data. In some implementations, transceiver 1226 may be capable of wirelessly communicating with different types of UEs/wireless networks of different RATs. In some implementations, transceiver 1226 may be equipped with a plurality of antenna ports (not shown) such as, for example, four antenna ports. That is, transceiver 1226 may be equipped with multiple transmit antennas and multiple receive antennas for MIMO wireless communications.

In some implementations, apparatus 1210 may further include a memory 1214 coupled to processor 1212 and capable of being accessed by processor 1212 and storing data therein. In some implementations, apparatus 1220 may further include a memory 1224 coupled to processor 1222 and capable of being accessed by processor 1222 and storing data therein. Each of memory 1214 and memory 1224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1214 and memory 1224 may include a type of read-only memory (ROM) such as mask ROM, programmable ROM (PROM), erasable programmable ROM (EPROM) and/or electrically erasable programmable ROM (EEPROM). Alternatively, or additionally, each of memory 1214 and memory 1224 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 1214 and memory 1224 may include a U ICC.

Each of apparatus 1210 and apparatus 1220 may be a communication entity capable of communicating with each other using various proposed schemes in accordance with the present disclosure. For illustrative purposes and without limitation, a description of capabilities of apparatus 1210, as a UE (e.g., UE 110), and apparatus 1220, as a network node (e.g., network node 125) of a wireless network (e.g., wireless network 120), is provided below.

Under a proposed scheme in accordance with the present disclosure with respect to informing an upper layer for originating an MO-MMTEL video call during network congestion in mobile communications, processor 1212 of apparatus 1210, implemented in or as UE 110, may identify a need (e.g., due to receiving a user input) to initiate an MO-MMTEL video call over a first domain. Additionally, processor 1212 may determine that there is a condition related to initiating the MO-MMTEL video call (e.g., a condition that prevents initiating the MO-MMTEL video call) over the first domain. Moreover, in response to the determining, processor 1212 may initiate, via transceiver 1216, the MO-MMTEL video call over a second domain different than the first domain.

In some implementations, processor 1212 may be configured to execute instructions (e.g., one or more sets of instructions 1218 stored in memory 1214) to perform functions such as EMM function 114, 5GMM function 116, as well as IMS function 112 as an upper layer function or entity. In such cases, in initiating the MO-MMTEL video call over the second domain, processor 1212 may execute instructions such that either EMM function 114 or 5GMM function 116 may notify IMS function 112 of the MO-MMTEL video call being unable to be initiated over the first domain. Moreover, the first domain may include an EPS or a 5GS, and the second domain may include a CS domain and/or a Wi-Fi access.

In some implementations, in determining that there is the condition, processor 1212 may perform operations. For instance, processor 1212 may execute instructions such that EMM function 114 may determine that a service request procedure cannot be initiated to initiate the MO-MMTEL video call over the first domain due to a T3346 timer or a T3325 timer running. Alternatively, processor 1212 may execute instructions such that EMM function 114 may determine that the apparatus is in an EMM-REGISTERED.ATTEMPTING-TO-UPDATE state and that the T3346 timer is running. Still alternatively, processor 1212 may execute instructions such that EMM function 114 may transmit, via transceiver 1216, to the network a service request procedure or a tracking area update procedure to initiate the MO-MMTEL video call over the first domain. In response, EMM function 114 may receive, via transceiver 1216, from the network a service reject message or a tracking area update reject message from the network with a cause indicating congestion and with a timer value for the T3346 timer.

In some implementations, in determining that there is the condition, processor 1212 may perform operations. For instance, processor 1212 may execute instructions such that 5GMM function 116 may determine that a service request procedure cannot be initiated to initiate the MO-MMTEL video call over the first domain due to a T3346 timer or a T3525 timer running. Alternatively, processor 1212 may execute instructions such that 5GMM function 116 may determine that the apparatus is in a 5GMM-REGISTERED.ATTEMPTING-REGISTRATION-UPDATE state and that the T3346 timer is running. Still alternatively, processor 1212 may execute instructions such that 5GMM function 116 may transmit, via transceiver 1216, to the network a service request procedure or a registration procedure for mobility and periodic registration update to initiate the MO-MMTEL video call over the first domain. In response, 5GMM function 116 may receive, via transceiver 1216, from the network a service reject message or a registration reject message from the network with a cause indicating congestion and with a timer value for the T3346 timer.

### Illustrative Processes

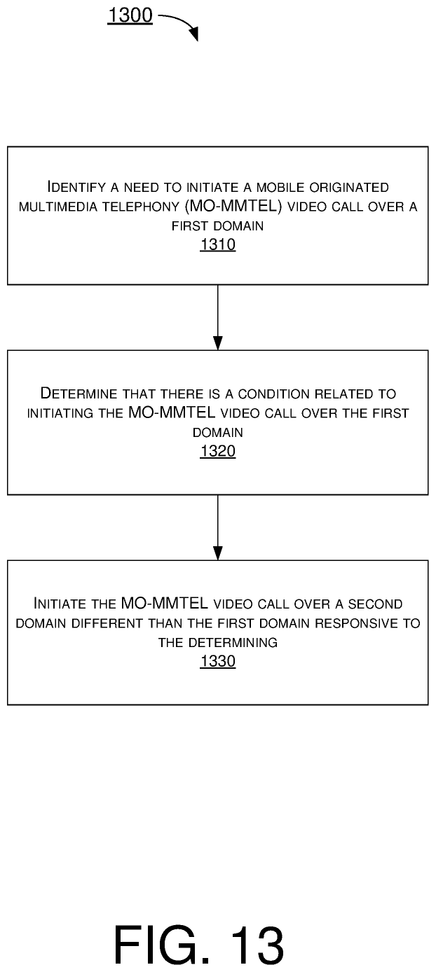

FIG. 13 illustrates an example process 1300 in accordance with an implementation of the present disclosure. Process 1300 may represent an aspect of implementing various proposed designs, concepts, schemes, systems and methods described above, whether partially or entirely, including those described above. More specifically, process 1300 may represent an aspect of the proposed concepts and schemes pertaining to informing an upper layer for originating an MO-MMTEL video call during network congestion in mobile communications. Process 1300 may include one or more operations, actions, or functions as illustrated by one or more of blocks 1310, 1320 and 1330. Although illustrated as discrete blocks, various blocks of process 1300 may be divided into additional blocks, combined into fewer blocks, or eliminated, depending on the desired implementation. Moreover, the blocks/sub-blocks of process 1300 may be executed in the order shown in FIG. 13 or, alternatively in a different order. Furthermore, one or more of the blocks/sub-blocks of process 1300 may be executed iteratively. Process 1300 may be implemented by or in apparatus 1210 and apparatus 1220 as well as any variations thereof. Solely for illustrative purposes and without limiting the scope, process 1300 is described below in the context of apparatus 1210 as a UE (e.g., UE 110) and apparatus 1220 as a communication entity such as a network node or base station (e.g., network node 125) of a wireless network (e.g., wireless network 120). Process 1300 may begin at block 1310.

At 1310, process 1300 may involve processor 1212 of apparatus 1210, implemented in or as UE 110, identifying a need (e.g., as a result of receiving a user input) to initiate an MO-MMTEL video call over a first domain. Process 1300 may proceed from 1310 to 1320.

At 1320, process 1300 may involve processor 1212 determining that there is a condition related to initiating the MO-MMTEL video call over the first domain (e.g., the condition prevents initiating the MO-MMTEL video call over the first domain). Process 1300 may proceed from 1320 to 1330.

At 1330, process 1300 may involve processor 1212, in response to the determining, initiating, via transceiver 1216, the MO-MMTEL video call over a second domain different than the first domain.

In some implementations, in determining that there is the condition, process 1300 may involve EMM function 114 executed by processor 1212 determining that there is the condition. Moreover, in initiating the MO-MMTEL video call, process 1300 may involve the EMM function 114, in response to determining that there is the condition, notifying IMS function 112 of the MO-MMTEL video call being unable to be initiated over the first domain.

In some implementations, in determining that there is the condition, process 1300 may involve EMM function 114 determining that a service request procedure cannot be initiated to initiate the MO-MMTEL video call over the first domain due to a T3346 timer or a T3325 timer running.

In some implementations, in determining that there is the condition, process 1300 may involve EMM function 114 determining that the UE is in an EMM-REGISTERED.ATTEMPTING-TO-UPDATE state and that a T3346 timer is running.

In some implementations, in determining that there is the condition, process 1300 may involve 5GMM function 116 executed by processor 1212 determining that there is the condition. Moreover, in initiating the MO-MMTEL video call, process 1300 may involve 5GMM function 116, in response to determining that there is the condition, notifying IMS function 112 of the MO-MMTEL video call being unable to be initiated over the first domain.

In some implementations, in determining that there is the condition, process 1300 may involve 5GMM function 116 determining that a service request procedure cannot be initiated to initiate the MO-MMTEL video call over the first domain due to a T3346 timer or a T3525 timer running.

In some implementations, in determining that there is the condition, process 1300 may involve 5GMM function 116 determining that the UE is in an 5GMM-REGISTERED.ATTEMPTING-REGISTRATION-UPDATE state and that a T3346 timer is running.

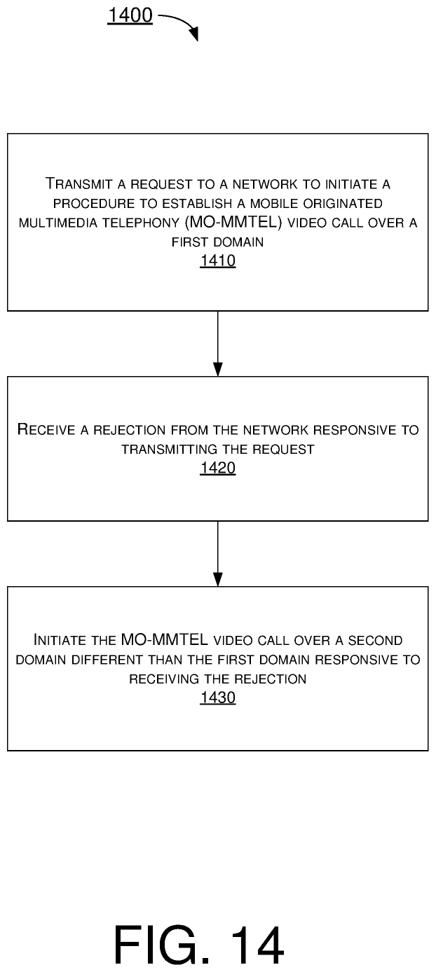

FIG. 14 illustrates an example process 1400 in accordance with an implementation of the present disclosure. Process 1400 may represent an aspect of implementing various proposed designs, concepts, schemes, systems and methods described above, whether partially or entirely, including those described above. More specifically, process 1400 may represent an aspect of the proposed concepts and schemes pertaining to informing an upper layer for originating an MO-MMTEL video call during network congestion in mobile communications. Process 1400 may include one or more operations, actions, or functions as illustrated by one or more of blocks 1410, 1420 and 1430. Although illustrated as discrete blocks, various blocks of process 1400 may be divided into additional blocks, combined into fewer blocks, or eliminated, depending on the desired implementation. Moreover, the blocks/sub-blocks of process 1400 may be executed in the order shown in FIG. 14 or, alternatively in a different order. Furthermore, one or more of the blocks/sub-blocks of process 1400 may be executed iteratively. Process 1400 may be implemented by or in apparatus 1210 and apparatus 1220 as well as any variations thereof. Solely for illustrative purposes and without limiting the scope, process 1400 is described below in the context of apparatus 1210 as a UE (e.g., UE 110) and apparatus 1220 as a communication entity such as a network node or base station (e.g., network node 125) of a wireless network (e.g., wireless network 120). Process 1400 may begin at block 1410.

At 1410, process 1400 may involve processor 1212 of apparatus 1210, implemented in or as UE 110, transmitting, via transceiver 1216, a request to a network (e.g., network 120 via apparatus 1220 as network node 125) to initiate a procedure to establish an MO-MMTEL video call over a first domain. Process 1400 may proceed from 1410 to 1420.

At 1420, process 1400 may involve processor 1212 receiving, via transceiver 1216, a rejection from the network in response to transmitting the request. Process 1400 may proceed from 1420 to 1430.

At 1430, process 1400 may involve processor 1212, in response to receiving the rejection, initiating, via transceiver 1216, the MO-MMTEL video call over a second domain different than the first domain.

In some implementations, in transmitting the request and the receiving of the rejection, process 1400 may involve EMM function 114 executed by processor 1212 transmitting the request and receiving the rejection. Moreover, in initiating the MO-MMTEL video call, process 1400 may involve EMM function 114, in response to receiving the rejection, notifying IMS function 112 of the MO-MMTEL video call being unable to be initiated over the first domain.

In some implementations, in transmitting the request to the network to initiate the procedure, process 1400 may involve EMM function 114 transmitting the request to the network to initiate a service request procedure or a tracking area update procedure.

In some implementations, in receiving the rejection, process 1400 may involve EMM function 114 receiving a service reject message or a tracking area update reject message from the network with a cause indicating congestion and with a timer value (e.g., a T3346 timer value).

In some implementations, the first domain may include an EPS, and the second domain may include a CS domain and/or a Wi-Fi access.

In some implementations, in transmitting the request and the receiving of the rejection, process 1400 may involve 5GMM function 116 executed by processor 1212 transmitting the request and receiving the rejection. Moreover, in initiating the MO-MMTEL video call, process 1400 may involve 5GMM function 116, in response to receiving the rejection, notifying IMS function 112 of the MO-MMTEL video call being unable to be initiated over the first domain.

In some implementations, in transmitting the request to the network to initiate the procedure, process 1400 may involve 5GMM function 116 transmitting the request to the network to initiate a service request procedure or a registration procedure for mobility and periodic registration update.

In some implementations, in receiving the rejection, process 1400 may involve 5GMM function 116 receiving a service reject message or a registration reject message from the network with a cause indicating congestion and with a timer value (e.g., a T3346 timer value).

In some implementations, the first domain may include a 5GS, and the second domain may include a CS domain and/or a Wi-Fi access.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
identifying a need to initiate a mobile originated multimedia telephony (MO-MMTEL) video call over a first domain;
determining that there is a condition related to initiating the MO-MMTEL video call over the first domain; and
initiating the MO-MMTEL video call over a second domain different than the first domain responsive to the determining.

2. The method of claim 1, wherein the determining that there is the condition comprises determining that there is the condition by an Evolved Packet System (EPS) Mobility Management (EMM) function at a user equipment (UE), and wherein the initiating of the MO-MMTEL video call comprises the EMM function, responsive to determining that there is the condition, notifying an Internet Protocol (IP) Multimedia Subsystem (IMS) function at the UE of the MO-MMTEL video call being unable to be initiated over the first domain.

3. The method of claim 2, wherein the determining that there is the condition comprises the EMM function determining that a service request procedure cannot be initiated to initiate the MO-MMTEL video call over the first domain due to a T3346 timer or a T3325 timer running.

4. The method of claim 2, wherein the determining that there is the condition comprises the EMM function determining that the UE is in an EMM-REGISTERED.ATTEMPTING-TO-UPDATE state and that a T3346 timer is running.

5. The method of claim 1, wherein the determining that there is the condition comprises determining that there is the condition by a 5th Generation Mobility Management (5GMM) function at a user equipment (UE), and wherein the initiating of the MO-MMTEL video call comprises the 5GMM function, responsive to determining that there is the condition, notifying an Internet Protocol (IP) Multimedia Subsystem (IMS) function at the UE of the MO-MMTEL video call being unable to be initiated over the first domain.

6. The method of claim 5, wherein the determining that there is the condition comprises the 5GMM function determining that a service request procedure cannot be initiated to initiate the MO-MMTEL video call over the first domain due to a T3346 timer or a T3525 timer running.

7. The method of claim 5, wherein the determining that there is the condition comprises the 5GMM function determining that the UE is in an 5GMM-REGISTERED.ATTEMPTING-REGISTRATION-UPDATE state and that a T3346 timer is running.

8. A method, comprising:
transmitting a request to a network to initiate a procedure to establish a mobile originated multimedia telephony (MO-MMTEL) video call over a first domain;
receiving a rejection from the network responsive to transmitting the request; and
initiating the MO-MMTEL video call over a second domain different than the first domain responsive to receiving the rejection.

9. The method of claim 8, wherein the transmitting of the request and the receiving of the rejection comprises transmitting the request and receiving the rejection by an Evolved Packet System (EPS) Mobility Management (EMM) function at a user equipment (UE), and wherein the initiating of the MO-MMTEL video call comprises the EMM function, responsive to receiving the rejection, notifying an Internet Protocol (IP) Multimedia Subsystem (IMS) function at the UE of the MO-MMTEL video call being unable to be initiated over the first domain.

10. The method of claim 9, wherein the transmitting of the request to the network to initiate the procedure comprises the EMM function transmitting the request to the network to initiate a service request procedure or a tracking area update procedure.

11. The method of claim 10, wherein the receiving of the rejection comprises the EMM function receiving a service reject message or a tracking area update reject message from the network with a cause indicating congestion and with a timer value.

12. The method of claim 8, wherein the first domain comprises an Evolved Packet System (EPS), and wherein the second domain comprises a circuit-switched (CS) domain or a Wi-Fi access.

13. The method of claim 8, wherein the transmitting of the request and the receiving of the rejection comprises transmitting the request and receiving the rejection by a 5th Generation Mobility Management (5GMM) function at a user equipment (UE), and wherein the initiating of the MO-MMTEL video call comprises the 5GMM function, responsive to receiving the rejection, notifying an Internet Protocol (IP) Multimedia Subsystem (IMS) function at the UE of the MO-MMTEL video call being unable to be initiated over the first domain.

14. The method of claim 13, wherein the transmitting of the request to the network to initiate the procedure comprises the 5GMM function transmitting the request to the network to initiate a service request procedure or a registration procedure for mobility and periodic registration update.

15. The method of claim 14, wherein the receiving of the rejection comprises the 5GMM function receiving a service reject message or a registration reject message from the network with a cause indicating congestion and with a timer value.

16. The method of claim 8, wherein the first domain comprises a 5th Generation System (5GS), and wherein the second domain comprises a circuit-switched (CS) domain or a Wi-Fi access.

17. An apparatus, comprising:
a transceiver configured to communicate wirelessly with a network; and
a processor coupled to the transceiver and configured to perform operations comprising:
identifying a need to initiate a mobile originated multimedia telephony (MO-MMTEL) video call over a first domain;
determining that there is a condition that prevents initiating the MO-MMTEL video call over the first domain; and
initiating, via the transceiver, the MO-MMTEL video call over a second domain different than the first domain responsive to the determining.

18. The apparatus of claim 17, wherein the processor is configured to execute instructions to perform an Evolved Packet System (EPS) Mobility Management (EMM) function and a 5th Generation Mobility Management (5GMM) function, wherein the processor is also configured to execute instructions to perform an Internet Protocol (IP) Multimedia Subsystem (IMS) function, wherein, in initiating the MO-MMTEL video call over the second domain, either the EMM function or the 5GMM function notifies the IMS function of the MO-MMTEL video call being unable to be initiated over the first domain, wherein the first domain comprises an Evolved Packet System (EPS) or a 5th Generation System (5GS), and wherein the second domain comprises a circuit-switched (CS) domain or a Wi-Fi access.

19. The apparatus of claim 18, wherein, in determining that there is the condition, the processor is configured to perform operations comprising:
the EMM function determining that a service request procedure cannot be initiated to initiate the MO-MMTEL video call over the first domain due to a T3346 timer or a T3325 timer running; or
the EMM function determining that the apparatus is in an EMM-REGISTERED.ATTEMPTING-TO-UPDATE state and that the T3346 timer is running; or
the EMM function performing:
transmitting, via the transceiver, to the network a service request procedure or a tracking area update procedure to initiate the MO-MMTEL video call over the first domain; and
receiving, via the transceiver, from the network a service reject message or a tracking area update reject message from the network with a cause indicating congestion and with a timer value for the T3346 timer.

20. The apparatus of claim 18, wherein, in determining that there is the condition, the processor is configured to perform operations comprising:
the 5GMM function determining that a service request procedure cannot be initiated to initiate the MO-MMTEL video call over the first domain due to a T3346 timer or a T3525 timer running; or
the 5GMM function determining that the apparatus is in a 5GMM-REGISTERED.ATTEMPTING-REGISTRATION-UPDATE state and that the T3346 timer is running; or
the 5GMM function performing:
transmitting, via the transceiver, to the network a service request procedure or a registration procedure for mobility and periodic registration update to initiate the MO-MMTEL video call over the first domain; and
receiving, via the transceiver, from the network a service reject message or a registration reject message from the network with a cause indicating congestion and with a timer value for the T3346 timer.
